(19) United States
(12) Patent Application Publication
(10) Pub. No.: US 2009/0311564 A1
(43) Pub. Date: Dec. 17, 2009

(54) FUEL CELL, ELECTRONIC DEVICE, AND FUEL SUPPLY METHOD

(75) Inventor: Seiichi Sawakami, Kanagawa (JP)

Correspondence Address: K&L Gates LLP, P. O. BOX 1135, CHICAGO, IL, 60690, US

(73) Assignee: SONY CORPORATION, Tokyo (JP)

(21) Appl. No.: 12/374,082

(22) PCT Filed: Aug. 7, 2007
(86) PCT No.: PCT/JP2007/065434

§ 371 Date: Jan. 16, 2009

(30) Foreign Application Priority Data
Aug. 11, 2006 (JP) 2006-219198
Mar. 2, 2007 (JP) 2007-052833

(51) Int. Cl. H01M 2/02; H01M 8/04

(52) U.S. Cl. 429/17; 429/34; 429/26

(57) ABSTRACT

A fuel cell capable of downsizing the battery with a simple structure is provided. Between a battery body and a fuel tank, a fuel diffusion layer in which the surface on the battery body side is a porous oxide film is provided. Further, a liquid fuel supplied from the fuel tank to the fuel diffusion layer is diffused in the porous oxide film. By capillary phenomenon due to minute holes, the liquid fuel is uniformly diffused to a wide range and then vaporized, and the vaporized fuel is supplied to respective battery cells 5A to 5C in the battery body. On the surface of the fuel diffusion layer on the battery body side, a groove section is provided radially from a fuel supply position toward the peripheral section of the fuel diffusion section. Thereby, the liquid fuel is moved in the groove section by using the capillary phenomenon irrespective of the direction of gravity, the influence of gravity according to posture difference is prevented, and the liquid fuel is uniformly supplied to the respective power generation sections.

### CROSS REFERENCE TO RELATED APPLICATIONS

The present application claims priority to Japanese Patent Application No. 2006-219198 filed on Aug. 11, 2006, and Japanese Patent Application No. 2007-052833 filed on Mar. 2, 2007, the entire contents of which are being incorporated herein by reference.

### BACKGROUND

In a fuel cell, hydrogen and oxygen are chemically reacted, and thereby water is generated and a current is obtained. The fuel cell is classified into a direct hydrogen polymer electrolyte type, a direct methanol type, a fuel reforming type, a phosphoric-acid type, a molten polymer electrolyte type, a solid oxide type and the like according to a supply method of hydrogen as a fuel and a reaction mechanism.

Of the foregoing, in recent years, research and development on the direct methanol type fuel cell in which methanol is directly oxidized has been actively considered, since both fuel handling and high energy density are relatively easily satisfied.

FIG. 26 shows a cross sectional structure of a structural example of a conventional direct methanol type fuel cell. In a fuel cell 101, a liquid fuel 121 composed of methanol water is contained in a fuel tank 120. At the upper central part in the fuel tank 120, a fuel pump 122 is provided, which is connected to a fuel diffusion sheet 103 via a nozzle 123. The surrounding area of the fuel diffusion sheet 103 is covered with a sealing section 141 and a separation sheet 142. Above the separation sheet 142, a battery body 105 composed of a plurality of battery cells 105A to 105C and a fuel leakage prevention sheet 143 are provided. In the fuel cell 101, the fuel diffusion sheet 103 is filled in with the liquid fuel 121 by the fuel pump 122 and the nozzle 123. In the fuel diffusion sheet 103, the liquid fuel 121 is vaporized while being diffused. In the separation sheet 142, only the vaporized fuel is supplied to and reaches the battery cells 105A to 105C. Thereby, in the respective battery cells 105A to 105C, power generation is operated.

Further, for example, Japanese Unexamined Patent Application Publication No. 2006-140153 discloses a fuel cell in which a flow path having a given shape is provided so that a liquid fuel is able to be smoothly diffused.

In the fuel cell shown in FIG. 26, however, diffusivity of the liquid fuel in the fuel diffusion sheet 103 is low. Thus, there has been a problem that immediately after the liquid fuel 121 is supplied from the nozzle 123, the liquid fuel 121 is vaporized only in the vicinity of the nozzle 123, and the fuel is supplied only to the battery cell right above the vicinity of the nozzle 123 (in this case, battery cell 105B). Therefore, at first, only partial power generating cell of the battery body 105 operates power generation, so positional variation is generated, and power generation efficiency is lowered. Thus, in order to prevent such a positional variation and uniformly diffuse the vaporized fuel, a given space domain 140 above the diffusion sheet 103 is necessitated, and thus it has been difficult to downsize the fuel cell.

Meanwhile, in Japanese Unexamined Patent Application Publication No. 2006-140153, there is a possibility that the flow path having a given shape enables the liquid fuel to be effectively diffused. However, since it is necessary to provide the flow path having a complicated shape, the manufacturing cost is high.

As described above, in the conventional fuel cell, it has been difficult to downsize the battery with a simple structure.

Further, in the structure shown in FIG. 26, there is a problem that according to posture difference of the fuel cell, diffusion of the liquid fuel 121 in the fuel diffusion sheet 103 becomes nonuniform, being affected by gravity. For example, in the case where the fuel cell is laid horizontally, as shown in FIG. 27, the liquid fuel 121 is almost uniformly diffused in the entire fuel diffusion sheet 103. However, in the case where the fuel cell is laid vertically, as shown in FIG. 28, the diffusion range of the liquid fuel 121 is heavily located below being affected by gravity, and the fuel is supplied only to the lower battery cell.

Therefore, for example, it is conceivable that a porous member such as a nonwoven cloth is filled in with the liquid fuel by capillary force to eliminate the influence of gravity (for example, refer to Japanese Unexamined Patent Application Publication No. 2000-106201). However, in this method, a large amount of liquid fuel with which the nonwoven cloth is filled in is necessitated. Thus, there is a problem such that even after the fuel supply is stopped, a considerable amount of liquid fuel is left in the nonwoven cloth, and vaporization of the fuel is not able to be quickly stopped.

As described above, in the conventional fuel cell, it has been difficult to uniformly supply the liquid fuel to the respective battery cells by preventing the influence of gravity according to posture difference.

### SUMMARY

The present invention relates to a fuel cell in which power generation is operated by reaction between hydrogen and oxygen, an electronic device including such a fuel cell, and a fuel supply method applied to the fuel cell.

In view of the foregoing problems, it is a first object of the present application to provide a fuel cell capable of downsizing the battery with a simple structure, an electronic device, and a fuel supply method.

It is a second object of the present application to provide a fuel cell capable of uniformly supplying a liquid fuel to respective power generation sections by preventing the influence of gravity according to posture difference and an electronic device including the fuel cell.

A first fuel cell of an embodiment includes a battery body including a power generation section; a fuel diffusion section that has a porous oxide film on a surface, diffuses a liquid fuel by the porous oxide film, and supplies the fuel to the power generation section; and a fuel tank that contains the liquid fuel, and supplies the liquid fuel to the porous oxide film.

A second fuel cell of an embodiment includes a battery body including a power generation section; a fuel tank that contains a liquid fuel; and a fuel diffusion section in which a groove section is provided radially from an inlet through which the liquid fuel is supplied from the fuel tank toward a peripheral section of the fuel diffusion section on a surface on the battery body side.

A first electronic device and a second electronic device of an embodiment respectively include the first fuel cell and the second fuel cell

A first fuel supply method of an embodiment is a method for supplying a liquid fuel contained in a fuel tank to a power generation section, in which the method supplies the liquid fuel to a porous oxide film, diffuses the liquid fuel by capillary phenomenon in the porous oxide film, and vaporizes the diffused liquid fuel and supplies the fuel to the power generation section.

A second fuel supply method of an embodiment is a method for supplying a liquid fuel contained in a fuel tank to a power generation section, in which the method supplies the liquid fuel to an inlet of a fuel diffusion section, moves the liquid fuel by capillary phenomenon in a groove section formed radially from the inlet toward a peripheral section of the fuel diffusion section, and vaporizes the moved liquid fuel and supplies the fuel to the power generation section.

In the first fuel cell and the first electronic device, the liquid fuel contained in the fuel tank is supplied to the porous oxide film. In the porous oxide film, the liquid fuel is diffused by capillary phenomenon due to a great number of minute holes. Then, the diffused liquid fuel is vaporized, and supplied to the power generation section.

In the second fuel cell and the second electronic device, the liquid fuel contained in the fuel tank is supplied to the inlet of the fuel diffusion section, is moved through the radial groove section by capillary phenomenon. In the case where the fuel diffusion section is arranged vertically, the liquid fuel is moved upward in the groove section defying the gravity. Therefore, the influence of gravity according to posture difference is prevented, and the liquid fuel is uniformly supplied to the respective power generation sections.

According to the first fuel cell or the first electronic device, the fuel diffusion section in which its surface is the porous oxide film is provided, and the liquid fuel supplied from the fuel tank to the fuel diffusion section is diffused in the porous oxide film. Thus, it is possible that with the use of the capillary phenomenon, the liquid fuel is uniformly diffused to a wide range and then vaporized, and supplied to the power generation section. Accordingly, the battery can be downsized with a simple structure.

According to the second fuel cell and the second electronic device, on the surface on the battery body side of the fuel diffusion section, the groove section is provided radially from the inlet toward the peripheral section of the fuel diffusion section. Therefore, the liquid fuel can be moved in the groove section by using the capillary phenomenon irrespective of the direction of gravity. Accordingly, the influence of gravity according to posture difference is prevented, and the liquid fuel can be uniformly supplied to the respective power generation sections.

According to the first fuel supply method, the liquid fuel contained in the fuel tank is supplied to the porous oxide film, the liquid fuel is diffused by the capillary phenomenon in the porous oxide film, and the diffused liquid fuel is vaporized and supplied to the power generation section. Thus, the vaporized fuel can be uniformly diffused. Accordingly, the battery can be downsized with a simple structure.

According to the second fuel supply method, the liquid fuel contained in the fuel tank is supplied to the inlet of the fuel diffusion section, the liquid fuel is moved by capillary phenomenon in the groove section formed radially from the inlet toward the peripheral section of the fuel diffusion section, and the moved liquid fuel is vaporized and supplied to the power generation section. Thus, even in the case where the fuel diffusion section is arranged vertically, the liquid fuel can be moved upward in the groove section defying the gravity. Therefore, the influence of gravity according to posture difference is prevented, and the liquid fuel can be uniformly supplied to the respective power generation sections.

Additional features and advantages are described herein, and will be apparent from, the following Detailed Description and the figures.

### BRIEF DESCRIPTION OF THE FIGURES

FIG. 1 A cross sectional view showing a structure of a fuel cell according to a first embodiment.

FIG. 2 A cross sectional view showing a detailed structure of the fuel diffusion layer shown in FIG. 1.

FIG. 3 Cross sectional views for explaining diffusion of a liquid fuel while comparing to a conventional example.

FIG. 4 Plan views for explaining the diffusion of the liquid fuel while comparing to the conventional example.

FIG. 5 Cross sectional view for explaining film thickness adjustment of a porous oxide film.

FIG. 6 A plan view and a cross sectional view showing a structure of a fuel cell according to a first modified example.

FIG. 7 A plan view and a cross sectional view showing a structure of a fuel cell according to a second modified example.

FIG. 8 A cross sectional view showing a structure of a fuel cell according to a third modified example.

FIG. 9 A cross sectional view showing a structure of a fuel cell according to a fourth modified example.

FIG. 10 A plan view showing a structure of a fuel diffusion layer of a fuel cell according to a second embodiment, which is viewed from a side where a groove section is formed.

FIG. 11 A cross sectional view showing an example of the groove section.

FIG. 12 A cross sectional view showing another example of the groove section.

FIG. 13 A cross sectional view showing still another example of the groove section.

FIG. 14 A cross sectional view showing still another example of the groove section.

FIG. 15 A cross sectional view showing still another example of the groove section.

FIG. 16 A cross sectional view showing still another example of the groove section.

FIG. 17 A plan view and a cross sectional view showing another structure of the fuel diffusion layer.

FIG. 18 A cross sectional view showing still another structure of the fuel diffusion layer.

FIG. 19 A perspective view for explaining an experiment for examining capillary force in the groove section.

FIG. 20 A diagram showing a calculation result of an elevation height of colored water in the case where a size of the gap shown in FIG. 19 is changed.

FIG. 21 A perspective view for explaining another experiment for examining the capillary force in the groove section.

FIG. 22 Cross sectional views showing a shape of a water surface in the groove section shown in FIG. 21.

FIG. 23 A cross sectional view showing still another example of the groove section.

FIG. 24 A cross sectional view showing still another example of the groove section.

FIG. 25 A cross sectional view showing still another example of the fuel diffusion layer.

FIG. 26 A cross sectional view showing a structure of a conventional fuel cell.

FIG. 27 A plan view and a cross sectional view for explaining a difference in fuel diffusion according to posture of the conventional fuel cell.

FIG. 28 A plan view and a cross sectional view for explaining a difference in fuel diffusion according to posture of the conventional fuel cell.

### DETAILED DESCRIPTION

Embodiments will be hereinafter described in detail with reference to the drawings.

### First Embodiment

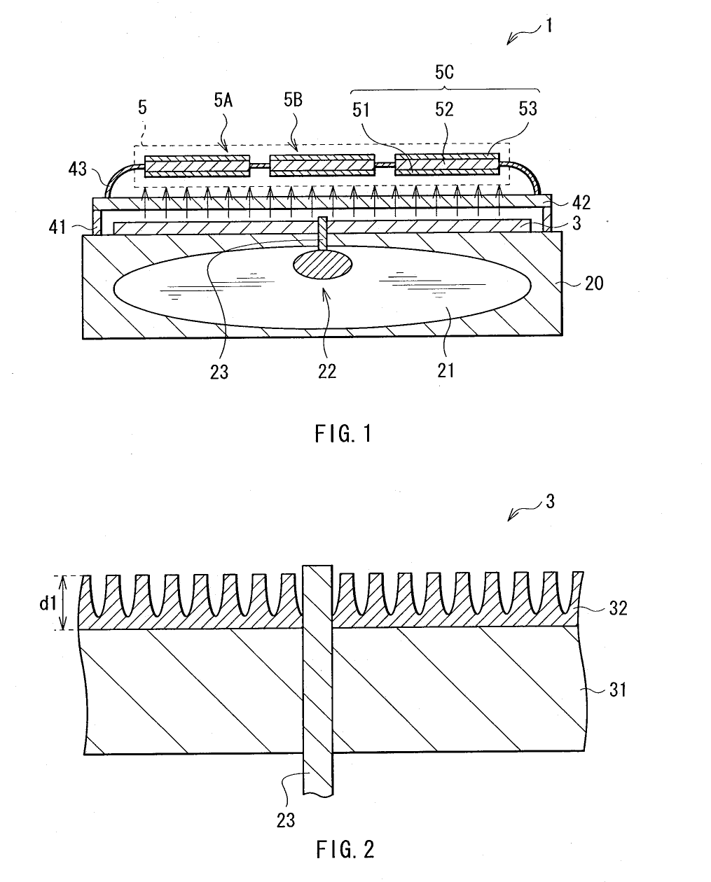

FIG. 1 shows a cross sectional structure of a fuel cell (fuel cell 1) according to a first embodiment. In addition, a first fuel supply method is embodied by a fuel cell system according to the embodiment, and thus a description thereof will be given as well.

The fuel cell 1 is provided with a fuel tank 20 containing a liquid fuel (for example, methanol water) 21. Above the fuel tank 20, a battery body 5 is provided. The battery body 5 includes a plurality of battery cells 5A to 5C arranged along the horizontal direction. In addition, the fuel tank 20 is composed of, for example, a container (for example, plastic bag) in which cubic volume changes without entry of air bubbles therein even if the liquid fuel 21 is increased or decreased and a rectangular solid case (structure) covering the container.

The respective battery cells 5A to 5C are direct methanol type power generation sections in which power generation is operated by reaction between hydrogen and oxygen. A fuel electrode (anode electrode, anode) 51 and an oxygen electrode (cathode electrode, cathode) 53 are oppositely arranged with an electrolyte film 52 in between. A not-shown air supply pump. is connected to the oxygen electrode 53. The fuel electrode 51 is formed on the fuel tank 20 side of the battery cells 5A to 5C. In addition, the electrolyte film 52 is composed of, for example, a proton conductor.

In the fuel tank 20, a fuel supply pump 22 for aspiring the liquid fuel in the fuel tank 20 and discharging the liquid fuel from a nozzle 23 is provided in the vicinity of the central upper portion thereof. Between the fuel tank 20 and the battery cells 5A to 5C, specifically, on the top face of the fuel tank 20, a fuel diffusion layer 3 for diffusing the liquid fuel 21 discharged from the nozzle 23 in the layer is formed. In addition, the nozzle 23 penetrates part of the fuel tank 20 and the fuel diffusion layer 3, and thereby the liquid fuel in the fuel tank 20 is supplied to the fuel diffusion layer 3.

FIG. 2 shows a cross sectional shape of the fuel diffusion layer 3 in details. The fuel diffusion layer 3 has a porous oxide film 32 (film thickness: d1) on a metal layer 31 (surface on the battery body 5 side).

The metal layer 31 is made of aluminum (Al) or an alloy thereof. The porous oxide film 32 is formed by providing given alumite treatment for the metal layer 31, and is made of aluminum oxide (Al₂O₃) or an aluminum oxide alloy. As shown in FIG. 2, in the porous oxide film 32, a great number of minute holes (for example, holes being about 10 nm in diameter) are formed along interlayer direction. Details of the alumite treatment in forming the porous oxide film 32 will be described later.

Descriptions will be given with reference to FIG. 1 again. In the surrounding area of the fuel diffusion layer 3 on the fuel tank 20, a sealing section 41 extends in interlayer direction. Above the fuel diffusion layer 3, a separation sheet 42 connected to the sealing section 41 is uniformly formed, where gas and liquid are able to be separated from each other. The separation sheet 42 is made of, for example, a polypropylene-based porous film or the like.

Above the separation sheet 42, the foregoing battery cells 5A to 5C are respectively arranged. The battery cells 5A to 5C are connected to each other by a fuel leakage prevention sheet 43, and the battery cells 5A to 5C and the separation sheet 42 are connected to each other by the fuel leakage prevention sheet 43. Thereby, leakage of the liquid fuel 21 passing the separation sheet 42 can be prevented.

The fuel cell 1 can be manufactured, for example, as follows.

First, the metal layer 31 made of the foregoing material is formed on the fuel tank 20 attached with the fuel supply pump 22 and the nozzle 23 by, for example sputtering method.

Next, given alumite treatment is provided for the metal layer 31 to form the porous oxide film 32. Specifically, first, as pretreatment for alumite treatment, degreasing treatment, edging treatment and the like are provided for the metal layer 31 to remove greases and natural oxide films on the surface of the metal layer 31. Next, alumite treatment is provided for the metal layer 31 to form the porous oxide film 32. At this time, for example, treatment is provided in a sulfuric acid layer, a chromium acid layer, an organic acid layer, a nitric acid layer, an oxalic acid layer, a boric acid layer or the like, while, for example, a direct current of about 1 (A/dm²) is applied. Temperature of the foregoing acid layer is set to, for example about 20 deg C. The surface state of the porous oxide film 32 is able to be adjusted by the temperature. The temperature is desirably increased, since thereby diffusion effect of the liquid fuel is able to be increased. For staining in the alumite treatment, an arbitrary color can be set. In general alumite treatment, sealing treatment is subsequently provided. However, in the alumite treatment of this embodiment, all or part of the sealing treatment is omitted to leave holes, and the sealing treatment is not completely provided.

Finally, the sealing section 41 and the separation sheet 42 are provided above the fuel diffusion layer 3 formed as described above, the battery body 5 made of the foregoing material and the fuel leakage prevention section 43 are further provided above the sealing section 41 and the separation sheet 42, and thereby the fuel cell system 1 shown in FIG. 1 is manufactured.

In the fuel cell system 1, the fuel diffusion layer 3 is filled in with the liquid fuel 21 contained in the fuel tank 20 by the fuel supply pump 22 and the nozzle 23. The liquid fuel 21 filled in the fuel diffusion layer 3 is diffused in the porous oxide film 32 on the surface of the fuel diffusion layer 3 and vaporized. The vaporized fuel passes through the separation sheet 42, reaches the respective battery cells 5A to SC, and is respectively supplied to the fuel electrodes 51 thereof. Meanwhile, air (oxygen) is supplied to the oxygen electrodes 53 of the respective battery cells 5A to 5C by a not-shown air supply pump. Then, in the respective fuel electrodes 51, reaction is initiated to generate hydrogen ions and electrons. Further, the hydrogen ions are moved to the oxygen electrode 53 through the electrolyte film 52, are reacted with electrons and oxygen, and thereby water is generated and carbon dioxide is generated as a by-product. Accordingly, in the fuel cell 1, power generation is operated.

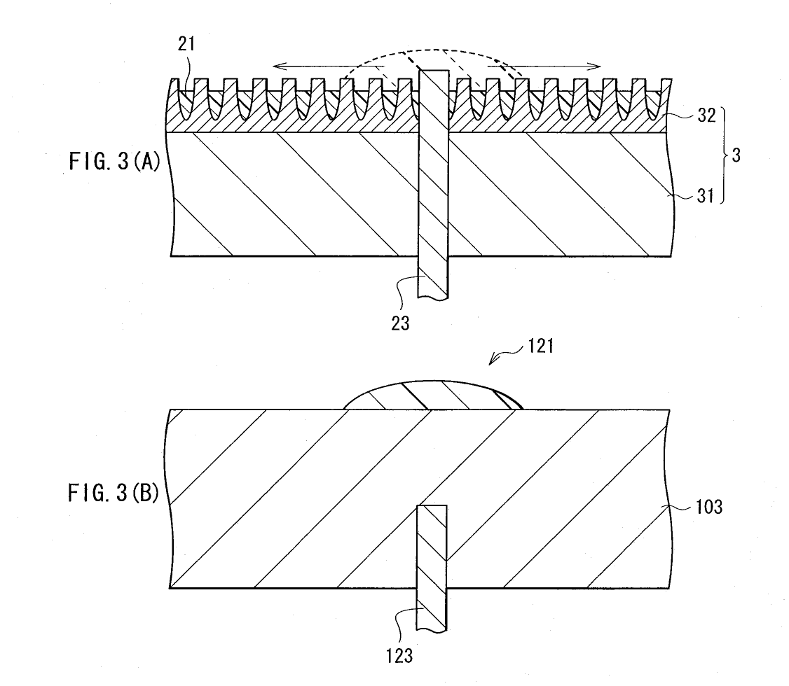

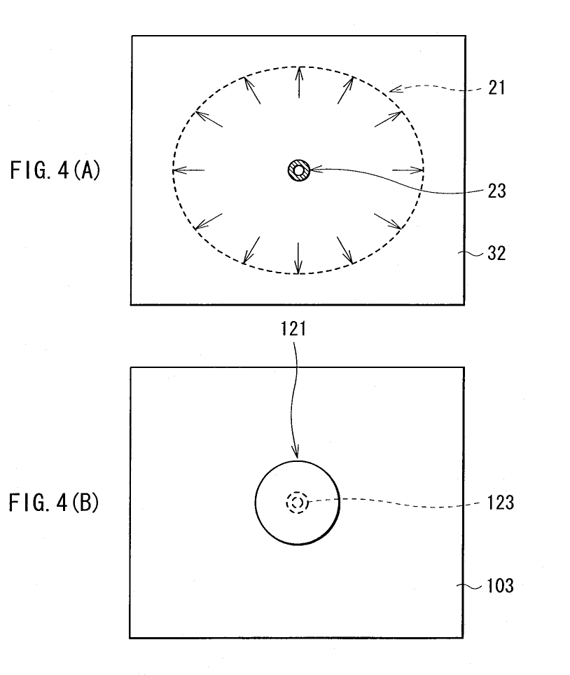

In this case, in the porous oxide film 32, the great number of minute holes is formed by the foregoing given alumite treatment. Thus, by capillary phenomenon resulting from the minute holes, for example, as respectively shown in the cross sectional view and the plan view in FIG. 3(A) and FIG. 4(A), the liquid fuel 21 supplied to the porous oxide film 32 is uniformly diffused to a wide range. In addition, in FIG. 3(A), the liquid fuel 21 is uniformly diffused down to the bottom of the holes. However, in some cases, the liquid fuel 21 may not diffused down to the bottom of the holes depending on the surface state of the porous oxide film 32 and the like.

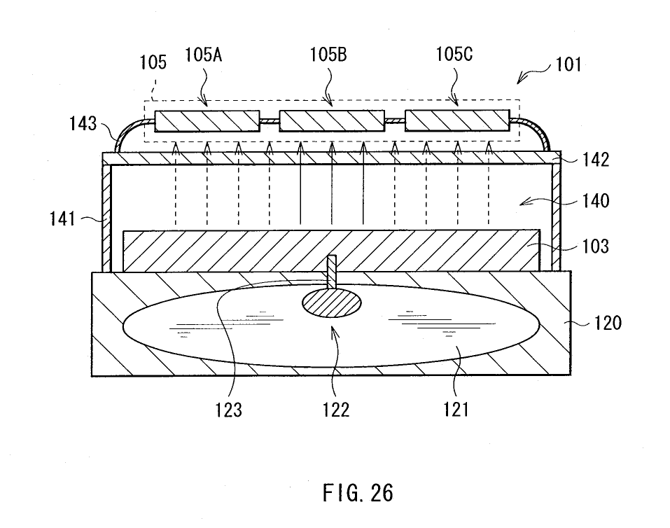

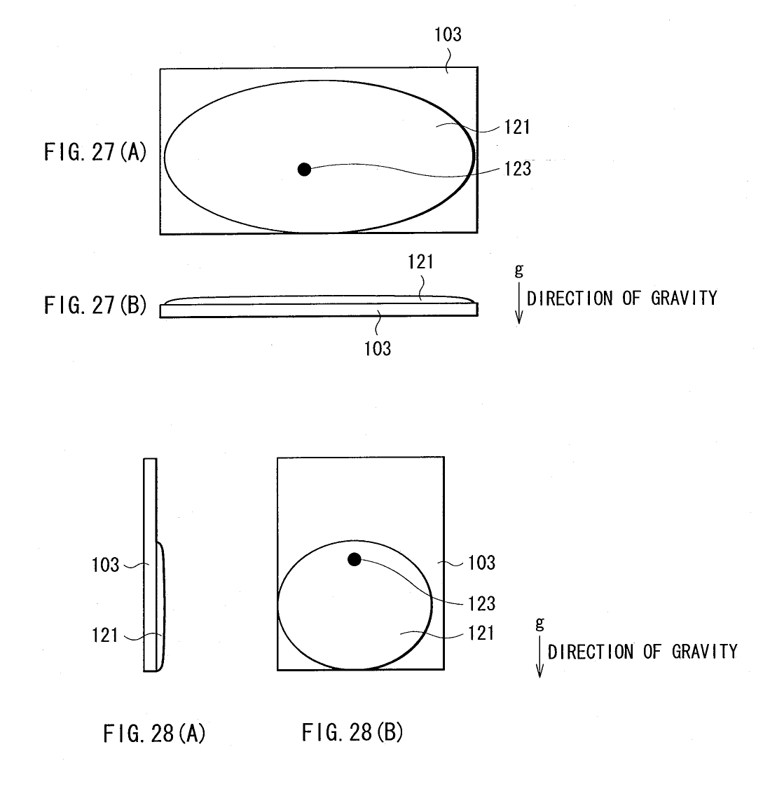

Meanwhile, in the conventional fuel cell 101 shown in FIG. 26, the liquid fuel 121 supplied to the fuel diffusion sheet 103 has low wet characteristics of the liquid fuel 121. on the fuel diffusion sheet 103. Thus, for example as respectively shown in the cross sectional view and the plan view in FIG. 3(B) and FIG. 4(B), compared to the case of the fuel cell 1 of this embodiment, the diffusion range is small.

As described above, in the fuel cell 1 of this embodiment, the liquid fuel 21 supplied to the porous oxide film 32 is uniformly diffused to a wide range. As a result, the vaporized fuel is not heavily located in the vicinity of the location over the nozzle 23, and is supplied to the battery body 5 with uniform state.

As described above, in this embodiment, the fuel diffusion layer 3 in which its surface on the battery body 5 side is the porous oxide film 32 is provided between the battery body 5 and the fuel tank 20, and the liquid fuel 21 supplied from the fuel tank 20 to the fuel diffusion layer 3 is diffused in the porous oxide film 32. Thus, it is possible that with the use of the capillary phenomenon due to the minute holes, the liquid fuel 21 is uniformly diffused to a wide range and then vaporized, and supplied to the respective battery cells 5A to 5C in the battery body 5. Thus, a space domain for uniformly diffusing the vaporized fuel, a flow path having a complicated shape for diffusing the liquid fuel and the like are not necessitated. Accordingly, the battery can be downsized with a simple structure.

Further, it is enough that only the given alumite treatment is provided for the metal layer 31 made of aluminum. Thus, the battery can be realized with inexpensive manufacturing cost.

Further, in general alumite treatment, after the minute holes are formed, sealing treatment for sealing the holes is provided. However, in the porous oxide film 32 of this embodiment, such sealing treatment is omitted. Thus, the foregoing effect is realized, and by omitting one step, the fuel diffusion layer 3 can be formed by an easier method than the general alumite treatment.

Further, the diffused liquid fuel 21 can be vaporized immediately after the liquid fuel 21 is diffused in the porous oxide film 32. Thus, fuel supply is enabled in a wide range with the small amount of liquid fuel 21 without leaving useless liquid fuel 21 after finishing power generation in the battery body 5. Therefore, use efficiency of the liquid fuel 21 can be improved, and power generation efficiency of the fuel cell 1 can be improved.

Moreover, the porous film is made of aluminum oxide that is most stable among aluminum compounds. Thus, for example, even in the case where the liquid fuel 21 is methanol, film alteration by methanol is able to be prevented, and deterioration with time is able to be avoided. Therefore, even after a long time elapses, stable power generation is enabled.

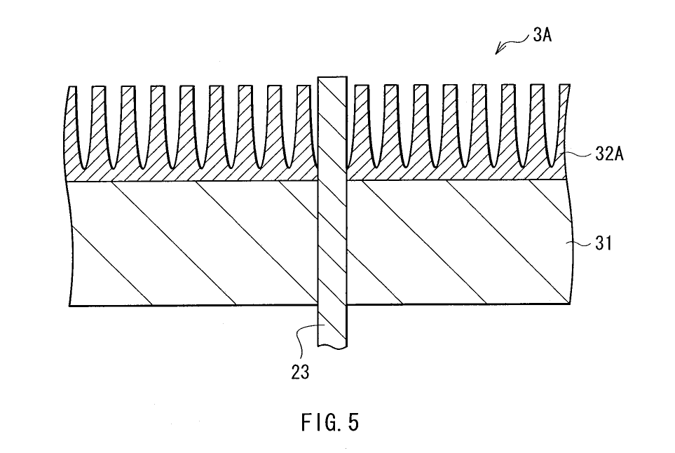

In the fuel cell 1 of this embodiment, for example, as a fuel diffusion layer 3A having a porous oxide film 32A (film thickness: d2) as shown in FIG. 5, the film thickness of the porous oxide film may be adjusted according to a diffusion rate of the liquid fuel 21 and a fuel retention amount. If structured as above, in addition to the effect of this embodiment, the film thickness adjustment of the porous oxide film enables adjusting the diffusion rate of the liquid fuel 21 and the fuel retention amount to an optimal value. In addition, the film thickness adjustment of the porous oxide film enables adjusting driving ability of the fuel supply pump 22, water retention conditions of the liquid fuel 21 and the like to an optimal value.

A description will be hereinafter given of modified examples (first to fourth) of the first embodiment.

### First Modified Example

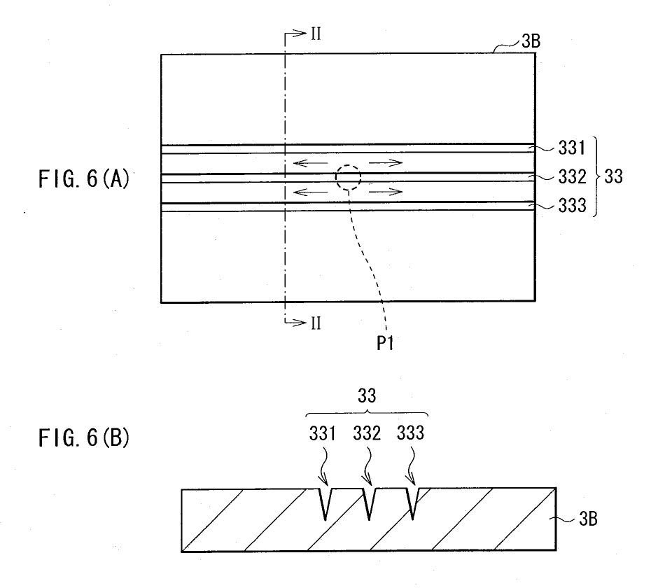

For example, as a fuel diffusion layer 3B respectively shown in FIG. 6(A) as a plan view and FIG. 6(B) as a cross sectional view taken along line II-II of FIG. 6(A), a groove section 33 (herein composed of a plurality of groove sections 331 to 333) formed by physical machining along a given direction may be formed on the surface on the battery body 5 side in the fuel diffusion layer. If structured as above, for example, as shown in FIG. 6(A), the liquid fuel in the portion indicated by P1 is able to be selectively diffused along the extending direction of the groove section 33 as shown in the arrows in the figure. Thus, in addition to the effect in the foregoing embodiment, the diffusion direction of the liquid fuel 21 can be arbitrarily controlled. Meanwhile, instead of the groove section formed by the physical machining as above, it is possible that a so-called alumite crack is intentionally formed on the porous oxide film 32, and the diffusion direction of the liquid fuel 21 is controlled by using the alumite crack.

### Second Modified Example

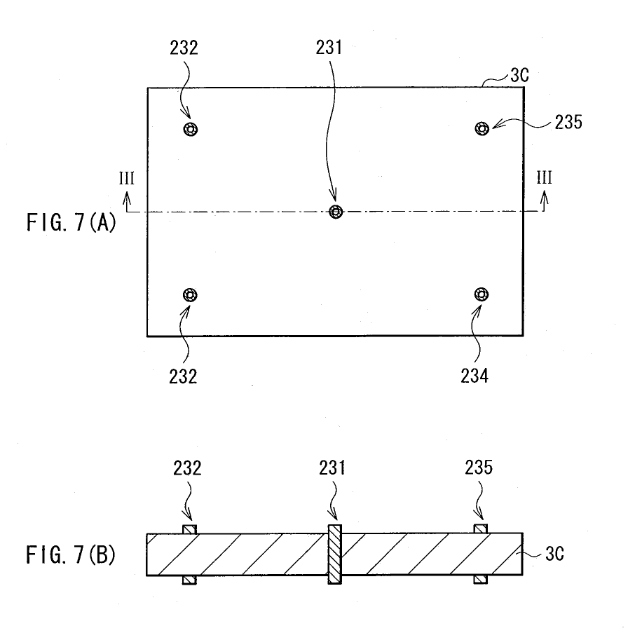

Further, for example, as a fuel diffusion layer 3C respectively shown in FIG. 7(A) as a plan view and FIG. 7(B) as a cross sectional view taken along line III-III of FIG. 7(A), a plurality of nozzles for supplying the liquid fuel 21 to the fuel diffusion layer may be provided and the number thereof may be increased (herein composed of five nozzles 231 to 235). If structured as above, it is possible that the diffusivity of the liquid fuel 21 is further improved, and the use efficiency of the liquid fuel 21 and the power generation efficiency of the fuel cell 1 are further improved.

### Third Modified Example

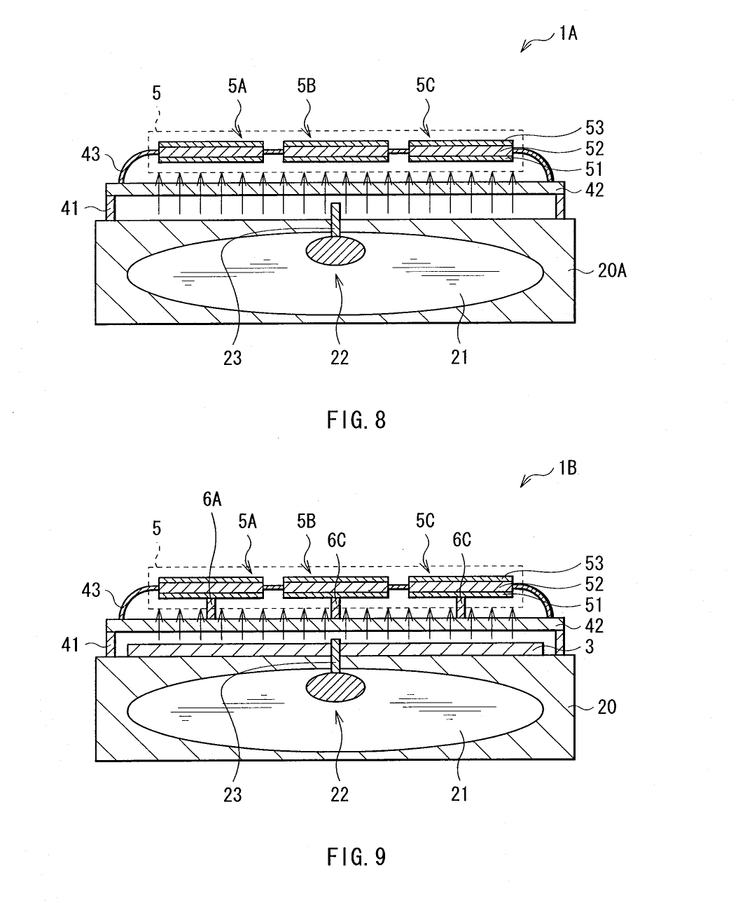

Further, for example, as a fuel cell 1A having a fuel tank 20A shown in FIG. 8, it is possible that the fuel tank itself is made of aluminum or an alloy thereof, and the top face, that is, the surface on the battery body 5 side is provided with alumite treatment to form a porous oxide film on the surface of the fuel tank. If structured as above, it is not necessary to form the fuel diffusion layer separately. Accordingly, the fuel cell can be further downsized with a simpler structure.

### Fourth Modified Example

Further, for example, as a fuel cell 1B shown in FIG. 9, it is possible that heat conductive sections 6A to 6C by which the respective battery cells 5A to 5C and the fuel diffusion layer 3 are connected is provided, and thereby heat generated in the respective battery cells 5A to 5C is conducted to the fuel diffusion layer 3. If structured as above, the heat generated in the respective battery cells 5A to 5C is used to increase temperature of the fuel diffusion layer 3, which enables further improvement of the diffusion efficiency in the porous oxide film 32. Further, since the porous oxide film 32 is made of the aluminum oxide having high heat conductivity, the heat conducted from heat conductive sections 6A to 6C can be quickly conducted to the entire film, and thus the effects thereof is large. Further, the heat generated in the respective battery cells 5A to 5C is effectively reusable, heat release in the battery body 5 can be effectively performed, and energy is effectively reusable.

### Second Embodiment

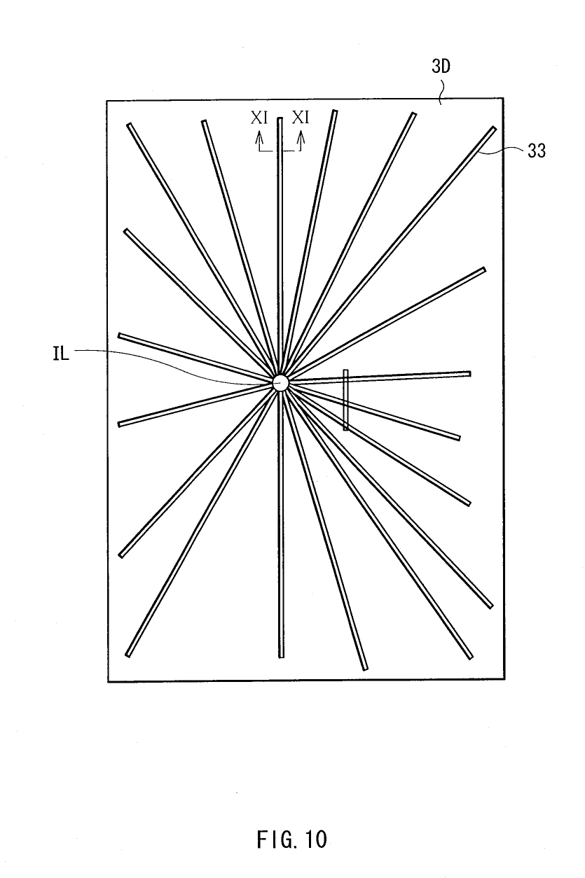

FIG. 10 shows a structure of a fuel diffusion layer of a fuel cell according to a second embodiment. The fuel cell is structured in the same manner as that of the foregoing first modified example and the foregoing first embodiment, except that the shape of the groove section 33 of a fuel diffusion layer 3D is different. Thus, a description will be given by affixing the same symbols to corresponding elements. A second fuel supply method is embodied by a fuel cell system according to this embodiment, and thus a description thereof will be given as well.

The fuel tank 20, the liquid fuel 21, the fuel supply pump 22, the battery body 5, the sealing section 41, the separation sheet 42, and the fuel leakage prevention section 43 are structured in the same manner as that of the first embodiment.

A component material of the fuel diffusion layer 3D is not particularly limited, but, for example, is preferably aluminum (Al) or an alloy containing aluminum (Al). Thereby, it is possible that temperature of the liquid fuel 21 is instantly increased by using the high heat conductivity, and vaporization efficiency of the liquid fuel 21 is improved.

On the surface of the fuel diffusion layer 3D on the battery body 5 side, a great number of groove sections 33 are formed radially from an inlet IL through which the liquid fuel 21 is supplied from the fuel tank 20 toward the peripheral section of the fuel diffusion section 3D. Thereby, in the fuel cell, it is possible that with the use of capillary phenomenon in the groove section 33, the liquid fuel 21 is uniformly supplied to the respective battery cells 5A to 5C by preventing the influence of gravity according to posture difference of the fuel cell.

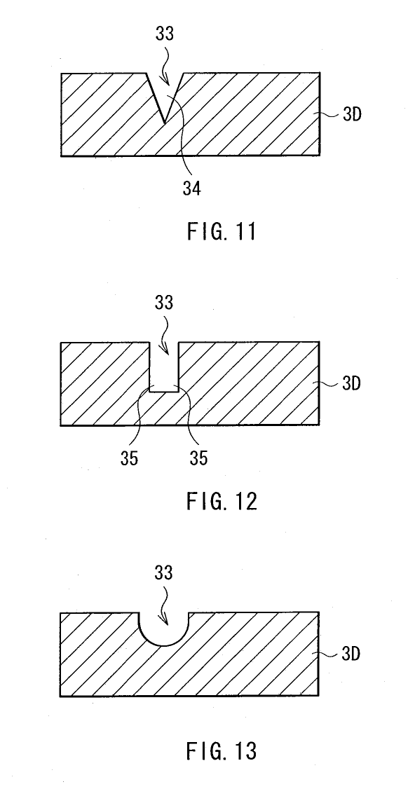

The cross sectional shape of the groove section 33 is not particularly limited. However, for example, a cross sectional shape composed of the inverted triangle (V-shape) shown in FIG. 11, the rectangle shown in FIG. 12, or a curved line (U-shape) such as a circle and an oval as shown in FIG. 13 is preferable. In the groove section 33 having the inverted triangle cross section, an acute angle section 34 on the tip is a narrow section. In the acute angle section 34, strong capillary phenomenon can be generated, and the acute angle section 34 is easily processed. The groove section 33 having the rectangle cross section has two angle sections 35 made by the bottom face and the side face. Thus, a constant capillary force is able to be ensured, and efficient fuel transport is enabled. The groove section 33 having the curved line cross section is suitable for a case emphasizing fuel transport efficiency, and is easily processed.

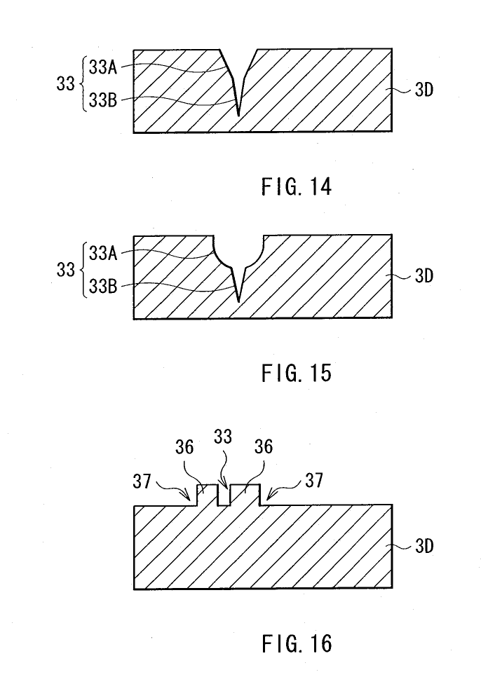

Further, as shown in FIG. 14 and FIG. 15, the groove section 33 may have a structure in which a plurality of (for example, two-staged) groove sections 33A and 33B are combined in the depth direction. Thereby, it is possible that the foregoing respective cross sectional shapes are combined and their advantages are further used. The cross sectional shape of the groove sections 33A and 33B are not particularly limited as well. Further, the groove sections 33A and 33B may have the same cross sectional shape, or may have a cross sectional shape different from each other. For example, as shown in FIG. 14, the groove sections 33A and 33B may have respective inversed triangle cross sections with a width different from each other. Otherwise, as shown in FIG. 15, it is possible that the groove section 33A has a cross sectional shape composed of a curved line such as a circle and an oval, and the groove section 33B has an inverted triangle cross sectional shape.

In addition, as shown in FIG. 16, it is possible that two projections 36 are provided on the surface of the fuel diffusion layer 3D on the battery body 5 side, and a gap between the projections 36 is structured as the groove section 33. In this case, a corner section 37 outside of the projection 36 is enabled to have a fuel transport function similar to the groove section 33,

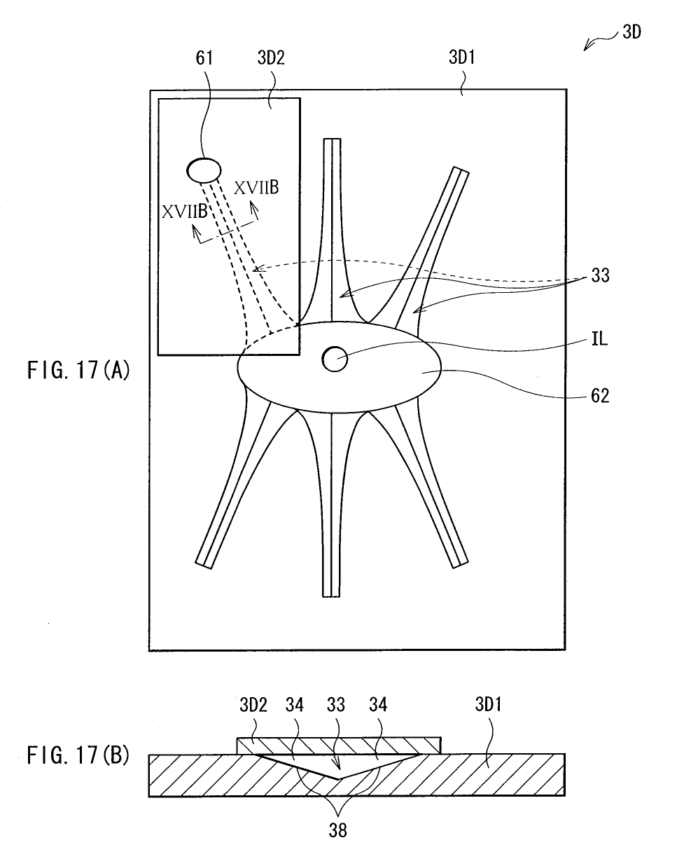

Furthermore, as shown in FIG. 17, the fuel diffusion layer 3D may have a fuel transport layer 3D1 provided with the groove section 33 and a covering layer 3D2 that covers the surface of the fuel transport layer 3D1 where the groove section 33 is provided. A side face of the groove section 33 is an inclined face 38. In the two acute angle sections 34 sandwiched between the inclined face 38 and the covering layer 3D2, capillary phenomenon is effectively generated. In this case, the cross sectional shape of the groove section 33 may have a hyperbolic shape or an inverted triangle having the two acute sections 34 as shown in FIG. 17(B), or may have a shape that has only one of the two acute angle sections 34. Further, though only the covering layer 3D2 provided on the upper left grove section 33 is shown in FIG. 17(A), the covering layer 3D2 needs to be provided to cover the all groove sections 33. However, it is enough that the covering layer 3D2 covers at least the groove section 33, and does not necessarily cover the entire face of the fuel transport layer 3D1. The covering layer 3D2 desirably exposes at least an end of the groove section 33, or has a hole 61 as an outlet of the liquid fuel 21 in at least the end of the groove section 33. In the surrounding area of the inlet IL of the fuel transport layer 3D1, a fuel pool 62 for temporarily pooling the supplied liquid fuel 21 may be provided.

The number of groove sections 33, the length in the extending direction thereof, and the in-plane distribution of the groove sections 33 shown in FIG. 10 and FIG. 17 are shown as an example, and are desirably set so that the liquid fuel 21 is spread into the entire fuel diffusion layer 3D according to the shape and the dimensions of the fuel diffusion layer 3D.

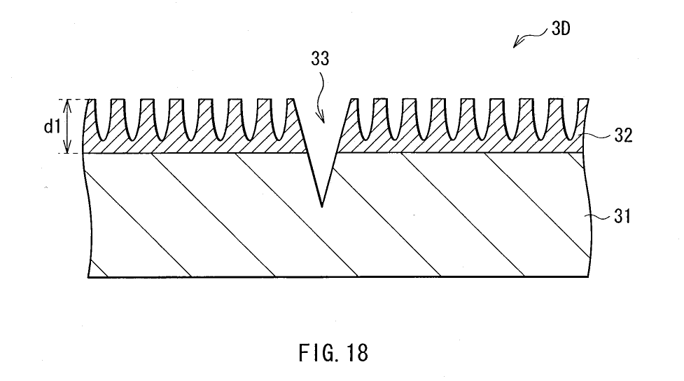

As shown in FIG. 18, the fuel diffusion layer 3D preferably has the porous oxide film 32 on the metal layer 31 (surface on the battery body 5 side) in the same manner as the fuel diffusion layer 3 of the first embodiment. Thereby, the liquid fuel 21 transported through the groove section 33 is able to be diffused and vaporized in the porous oxide film 32, and higher effects can be obtained due to synergetic effects thereof. The groove section 33 may be deeper than the film thickness d1 of the porous oxide film 32 and may reach the metal layer 31. Otherwise, the groove section 33 may be shallower than the film thickness d1 of the porous oxide film 32. In FIG. 18, a case that the cross sectional shape of the groove 33 is the inverted triangle is shown. However, in the case where the porous oxide film 32 is formed, the cross sectional shape of the groove section 33 is not particularly limited as well.

The fuel cell can be manufactured, for example, as follows.

First, in the same manner as that of the first embodiment, the metal layer 31 made of the foregoing material is formed on the fuel tank 20 attached with the fuel supply pump 22 and the nozzle 23. Next, in the same manner as that of the first embodiment, given alumite treatment is provided for the metal layer 31 to form the porous oxide film 32.

Subsequently, on the surface of the porous oxide layer 32, for example, a great number of groove sections 33 are formed radially from the inlet IL toward the peripheral section by, for example, die cutting, etching, or physical machining using a cutter or the like to form the fuel diffusion layer 3D.

Finally, in the same manner as that of the first embodiment, above the fuel diffusion layer 3D formed as described above, the sealing section 41 and the separation sheet 42 are provided. Further, the battery body 5 made of the foregoing material and the fuel leakage protection section 43 are provided above the sealing section 41 and the separation sheet 42. Accordingly, the fuel cell system of this embodiment is manufactured.

In the fuel cell system, the liquid fuel 21 contained in the fuel tank 20 is supplied to the fuel diffusion layer 3D. The fuel that is diffused and vaporized in the fuel diffusion layer 3D passes the separation sheet 42, reaches the respective battery cells 5A to 5C, and is supplied to the fuel electrodes 51 thereof. Meanwhile, air (oxygen) is supplied to the oxygen electrodes 53 of the respective battery cells 5A to 5C by a not-shown air supply pump. Then, in the respective fuel electrodes 51, reaction is initiated to generate hydrogen ions and electrons. Further, the hydrogen ions are moved to the oxygen electrode 53 though the electrolyte film 52, and are reacted with electrons and oxygen, and thereby water is generated and carbon dioxide is generated as a by-product. Accordingly, in the fuel cell, power generation is operated.

At this time, since on the surface of the fuel diffusion layer 3D on the battery body 5 side, the great number of groove sections 33 is provided radially from the inlet IL toward the peripheral section, the liquid fuel 21 supplied to the inlet IL is moved through the radial groove 33 by capillary phenomenon, and immediately after being supplied, the liquid fuel 21 is instantly spread over the fuel diffusion layer 3D without any special pump or the like. Therefore, it is not necessary to fill. in the porous member such as a nonwoven cloth with abundant liquid fuel for uniform diffusion as in Japanese Unexamined Patent Application Publication No. 2000-106201. Further, in the case where power generation is stopped, vaporization is quickly stopped by stopping supplying the fuel. Therefore, useless fuel supply is prevented, and a small amount of liquid fuel is effectively used.

Further, in the case where the fuel diffusion layer 3D is laid vertically, the liquid fuel 21 is moved upward in the groove section 33 defying the gravity. Therefore, the influence of gravity according to posture difference is prevented, and the liquid fuel 21 is uniformly supplied to the respective battery cells 5A to 5C. On the other hand, in the conventional fuel cell shown in FIG. 28, in the case where the fuel cell is laid vertically, the diffusion range of the liquid fuel 121 supplied to the fuel diffusion sheet 103 is heavily located below by its own weight.

Furthermore, the porous oxide film 32 is provided on the surface of the fuel diffusion layer 3D. Thus, the liquid fuel 21 moved through the groove section 33 is supplied from the side face of the groove 33 to the porous oxide film 32, and the liquid fuel 21 is uniformly diffused to a wide range by the capillary phenomenon due to the great number of minute holes of the porous oxide film 32. Therefore, the liquid fuel 21 is more uniformly diffused and the diffusion range is expanded due to synergy effect of the groove section 33 and the porous oxide film 32.

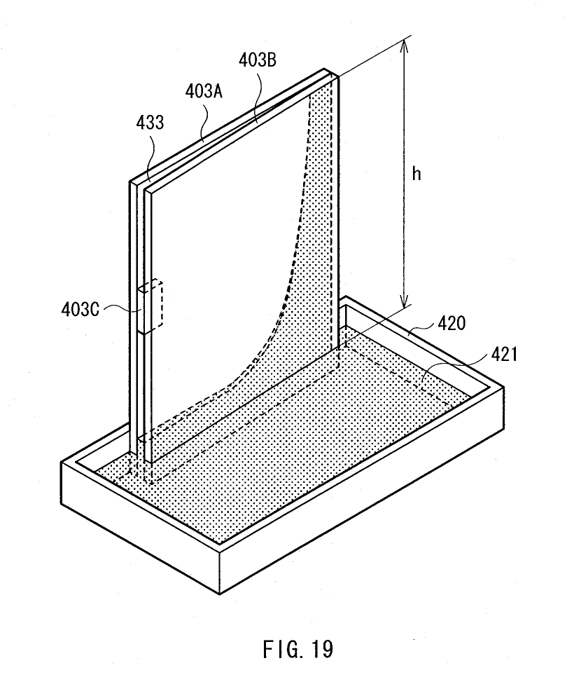

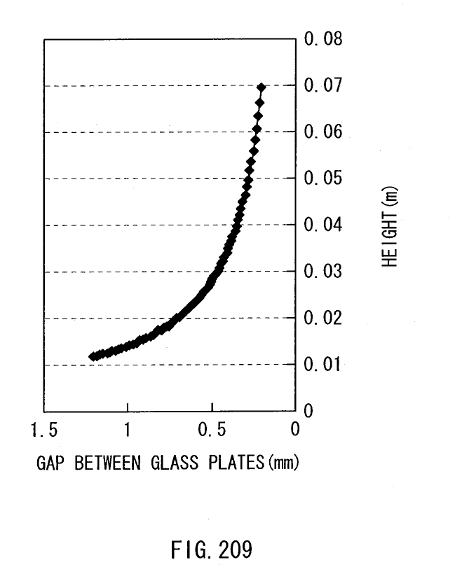

In addition, the capillary phenomenon is a phenomenon that a liquid level is moved upward (downward) from the external free surface in a small tube, in a narrow gap between solid walls and the like inserted in liquid. Elevation height h of the liquid level in a tube is obtained by Mathematical formula 1. For example, in the case where the elevation height h of the water surface in a glass tube being 0.1 mm in diameter based on the seawater surface altitude is calculated with the use of Mathematical formula 1, it results in about 28 cm. However, the groove section 33 of this embodiment is not a tube, Thus, the elevation height h of the liquid level in the groove section 33 was actually calculated as shown in FIG. 19. One side of two glass plates 403A and 403B was contacted with each other, and a spacer 403C being 1.2 mm thick was sandwiched between each side opposed to the foregoing one side to form a gap 433 having an inverted triangle cross section corresponding to the groove section 33. The glass plates 403A and 403B were set up in a water bath 420 containing colored water 421 corresponding to the liquid fuel 21. Then, the colored water 421 was moved upward in the gap 433. The elevation height h from the water surface of the colored water 421 in the water bath 420 to the uppermost position in the gap 433 was about 6 cm.

### Mathematical Formula 1

h=2Tcosθ/ρgr

(In the formula, h represents the elevation height of the liquid level (m), T represents a surface tension (N/m), θ represents a contact angle, ρ represents a density of the liquid (kg/m³), g represents a gravity acceleration (m/s²), and r represents an internal diameter (radius) of the tube (m), respectively. In the case of water, the surface tension T is 0.0728 N/m (20 deg C.), the contact angle θ is 20 deg C., the density ρ is 1000 kg/M³, and the gravity acceleration g is 9.80665 m/s².

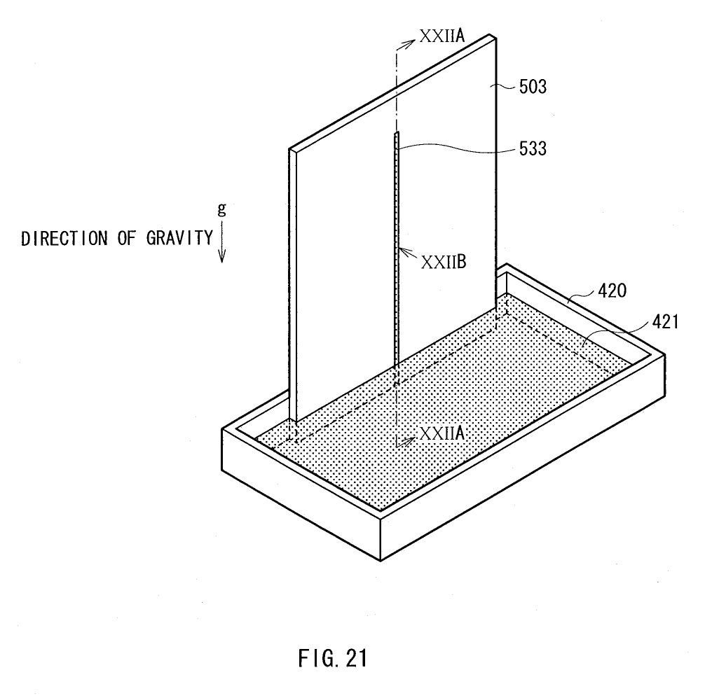

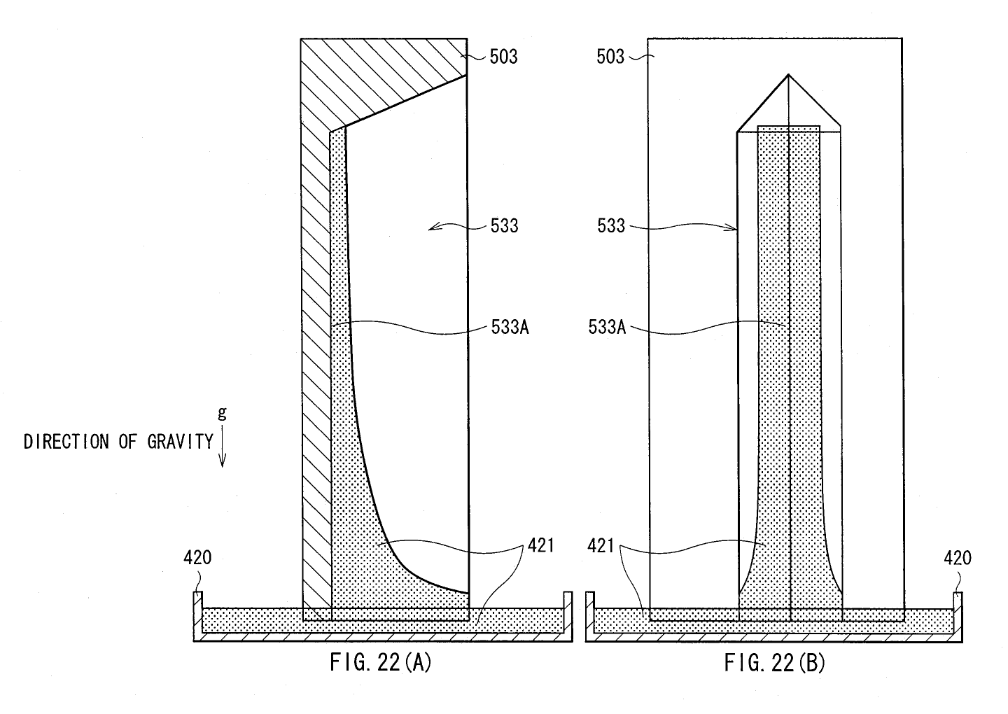

FIG. 20 shows a result of the elevation height h calculated based on Mathematical formula 1 of the colored water 421 in the case where the size of the gap 433 was changed. The calculation result of FIG. 20 favorably corresponds to the actual shape of the water surface in the gap 433 shown in FIG. 21. It is therefrom found that the elevation of the water surface in the gap 433 corresponding to the gap section 33 is based on the capillary phenomenon. Therefore, even in the case where instead of the glass plates 403A and 403B, as shown in FIG. 21, a groove section 533 is formed in a glass plate 503, and the glass plate 503 is set up in the water bath 420 containing the colored water 421 so that the extending direction of the groove section 533 corresponds to the direction of gravity g, as shown in FIG. 22, it is conceivable that the shape of the water surface in the groove section 533 is subject to the capillary phenomenon in the same manner as the shape of the water surface in the gap 433 shown in FIG. 19 and FIG. 20.

As described above, in this embodiment, on the surface of the fuel diffusion layer 3D on the battery body 5 side, the great number of groove sections 33 is provided radially from the inlet IL toward the peripheral section. Thus, even in the case where the fuel diffusion layer 3D is laid vertically, the liquid fuel 21 is able to be moved upward in the groove section 33 defying the gravity. Therefore, the influence of gravity according to posture difference is prevented, and the liquid fuel 21 is able to be uniformly supplied to the respective battery cells 5A to 5C.

Further, the liquid fuel 21 supplied to the inlet IL is moved through the radial groove section 33 by the capillary phenomenon, and immediately after being supplied, the liquid fuel 21 is able to be instantly spread over the fuel diffusion layer 3D without any special pump or the like. Therefore, it is not necessary to fill in the porous member such as a nonwoven cloth with abundant liquid fuel for uniform diffusion as in Japanese Unexamined Patent Application Publication No. 2000-106201. Further, in stopping power generation, vaporization is able to be quickly stopped by stopping supplying the fuel. Therefore, useless fuel supply is prevented, and power generation is enabled by using a small amount of liquid fuel effectively.

In particular, since the porous oxide film 32 is formed on the surface of the fuel diffusion layer 3D on the battery body 5 side, it is possible that the liquid fuel 21 transported through the groove 33 is diffused more uniformly and in a wide range in the porous oxide film 32. and then vaporized, and supplied to the respective battery cells 5A to 5C in the battery body 5.

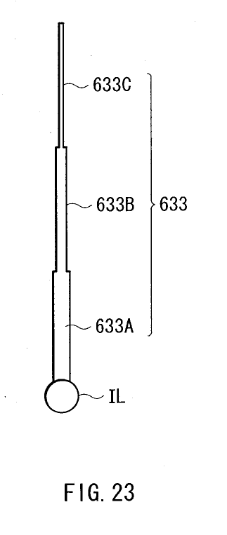

In the foregoing second embodiment, the description has been given of a case that the width and the cross sectional shape of the groove section 33 are identical over the entire extending direction. However, at least one of the width and the cross sectional shape of the groove section 33 may be adjusted to improve the capillary force according to the distance from the inlet IL. In the case where the width is adjusted, it is necessary that as the distance from the inlet IL is larger, the width is smaller. This is because if the width is larger as the distance from the inlet IL is larger, the liquid fuel 21 is not able to be transported. For example, as shown in FIG. 23, it is possible that a groove section 633 has a structure in which groove sections 633A, 633B, and 633C having a width different from each other in a plurality of stages (for example, three stages) are linked in the order from the inlet IL side, and as the distance from the inlet IL is larger, the width of the groove sections 633A, 633B, and 633C is smaller. FIG. 23 shows only one of the great number of groove sections 633 extending from the inlet IL.

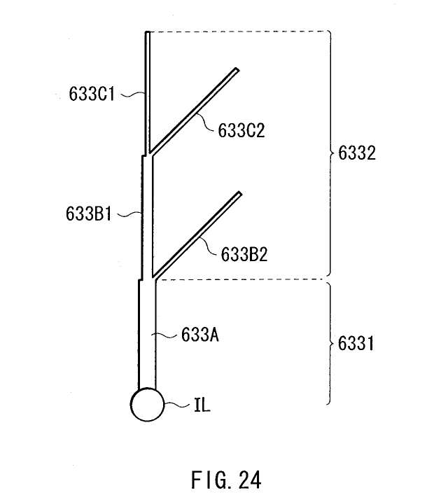

Further, in the foregoing second embodiment, the description has been given of a case that the groove section 33 is not branched. However, as shown in FIG. 24, the groove section 633 may have a main groove section 6331 extending from the inlet IL (groove section 633A) and a branched groove section 6332 that is branched from the main groove section 6331 (groove sections 633B1 and 633B2, and groove sections 633C1 and 633C2). In this case, the width of the branched groove section 6332 may be smaller than that of the main groove section 6331. Further, it is possible that in the branched groove section 6332, as the distance from the inlet IL is larger, the width is smaller. FIG. 24 shows only one of the great number of groove sections 633 extending from the inlet IL.

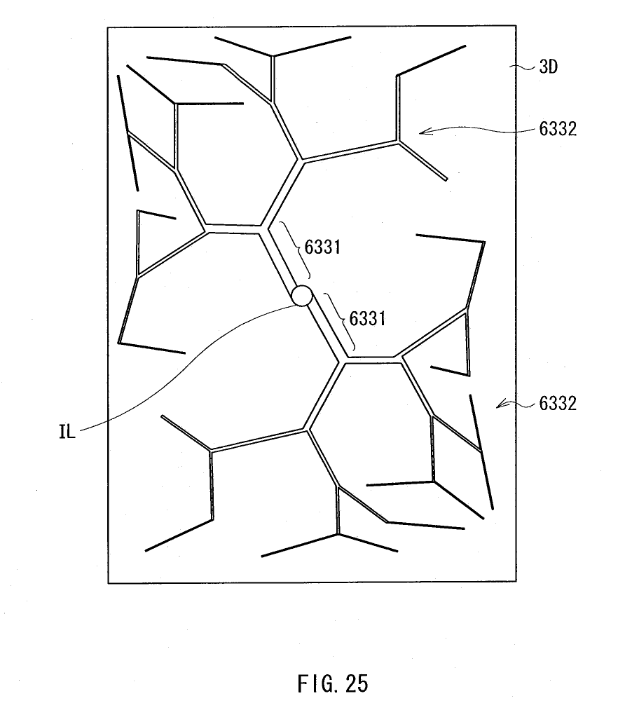

Further, as shown in FIG. 25, the branched groove section 6332 may be branched into many stages. In this case, the width of the branched groove section 6332 may be smaller than that of the main groove section 6331. Further, it is possible that in the branched groove section 6332, as the distance from the inlet IL is larger, the width is smaller.

The present application has been described with reference to the embodiments. However, the present application is not limited to the foregoing embodiments, and various modifications may be made. For example, in the foregoing embodiments, the description has been specifically given of the structure of the fuel cell. However, the fuel cell may have other structure or may be made of other material. For example, in the foregoing second embodiment, the description has been given of the case that the porous oxide film 32 is formed together with the groove section 33 on the surface of the fuel diffusion layer 3D on the battery body 5 side. However, the fuel diffusion section for diffusing the liquid fuel and supplying the fuel to the power generation section may have the groove section 33 on the surface of the metal layer 31, and the porous oxide film 32 may be omitted. Further, for example, the material and the thickness of each element, or power generation conditions of the fuel cell and the like are not limited to those described in the foregoing embodiments. Other material, other thickness, or other power generation conditions may be adopted. Further, for example, the liquid fuel 21 may be other liquid fuel such as ethanol and dimethyl ether in addition to the methanol.

In addition, the present application is applicable not only to the fuel cell using the liquid fuel, but also to a fuel cell using a material as a fuel other than the liquid fuel such as hydrogen.

Furthermore, in the foregoing embodiments, the description has been given of the fuel cell in which the plurality of battery cells 5A to 5C is electrically connected. However, the present application is applicable to a single-cell type fuel cell.

In addition, in the foregoing embodiments, the description has been given of the case that the present application is applied to the fuel cell and the electronic devices including the fuel cell. However, in addition to the fuel cell, the present application is applicable to other electrochemical device such as a capacitor, a fuel sensor, and a display.

The fuel cell of an embodiment can be suitably used for a mobile electronic device such as a mobile phone, an electronic camera, an electronic data book, a notebook size personal computer, a camcorder, a portable video game player, a portable video player, a headphone stereo, and a PDA (Personal Digital Assistants). In such an electronic device, downsizing of the fuel cell is able to be realized easily. Therefore, the entire electronic device can be downsized easily as well, and thus decrease of the manufacturing cost is enabled as well.

It should be understood that various changes and modifications to the presently preferred embodiments described herein will be apparent to those skilled in the art. Such changes and modifications can be made without departing from the spirit and scope of the present invention and without diminishing its intended advantages. It is therefore intended that such changes and modifications be covered by the appended claims.

1-15. (canceled)

16. A fuel cell comprising:
a battery body including a power generation section;
a fuel diffusion section that has a porous oxide film on a surface, diffuses a liquid fuel by the porous oxide film, and supplies the fuel to the power generation section; and
a fuel tank that contains the liquid fuel, and supplies the liquid fuel to the porous oxide film.

17. The fuel cell according to claim 16, wherein a thickness of the porous oxide film is adjusted according to at least one of a diffusion rate and a retention amount of the liquid fuel.

18. The fuel cell according to claim 16, wherein a groove section along a given direction is formed on a surface on the battery body side in the fuel diffusion section.

19. The fuel cell according to claim 18, wherein the groove section is formed radially from an inlet through which the liquid fuel is supplied from the fuel tank toward a peripheral section of the fuel diffusion section.

20. The fuel cell according to claim 19, wherein at least one of a width and a cross sectional shape of the groove section is adjusted according to a distance from the inlet.

21. The fuel cell according to claim 19, wherein the groove section has a main groove section that extends from the inlet and a branched groove section that is branched from the main groove section.

22. The fuel cell according to claim 16, wherein a heat conductive section that conducts heat generated in the power generation section to the fuel diffusion section is included.

23. The fuel cell according to claim 16, wherein the porous oxide film is formed by providing alumite treatment for aluminum or an alloy thereof.

24. A fuel cell comprising:
a battery body including a power generation section;
a fuel tank that contains a liquid fuel; and
a fuel diffusion section in which a groove section is provided radially from an inlet through which the liquid fuel is supplied from the fuel tank toward a peripheral section of the fuel diffusion section on a surface on the battery body side.

25. The fuel cell according to claim 24, wherein at least one of a width and a cross sectional shape of the groove section is adjusted according to a distance from the inlet.

26. The fuel cell according to claim 24, wherein the groove section has a main groove section that extends from the inlet and a branched groove section that is branched from the main groove section.

27. An electronic device including a fuel cell, the fuel cell comprising:
a battery body including a power generation section;
a fuel diffusion section that has a porous oxide film on a surface, diffuses a liquid fuel by the porous oxide film, and supplies the fuel to the power generation section; and
a fuel tank that contains the liquid fuel, and supplies the liquid fuel to the porous oxide film.

28. An electronic device including a fuel cell, the fuel cell comprising:
a battery body including a power generation section;
a fuel tank that contains a liquid fuel; and
a fuel diffusion section in which a groove section is provided radially from an inlet through which the liquid fuel is supplied from the fuel tank toward a peripheral section of the fuel diffusion section on a surface on the battery body side.

29. A fuel supply method for supplying a liquid fuel contained in a fuel tank to a power generation section, the method comprising:
supplying the liquid fuel to a porous oxide film,
diffusing the liquid fuel by capillary phenomenon in the porous oxide film, and
vaporizing he diffused liquid fuel and supplying the liquid fuel to the power generation section.

30. A fuel supply method for supplying a liquid fuel contained in a fuel tank to a power generation section, the method comprising:
supplying the liquid fuel to an inlet of a fuel diffusion section,
moving the liquid fuel by capillary phenomenon in a groove section formed radially from the inlet toward a peripheral section of the fuel diffusion section, and
vaporizing the moved liquid fuel and supplying the liquid fuel to the power generation section.
